(19) United States
(12) Patent Application Publication
(10) Pub. No.: US 2024/0282972 A1
(43) Pub. Date: Aug. 22, 2024

(54) LITHIUM ION BATTERY

(71) Applicant: Thomas Gerhard Wilhelm Damitz, Qingdao (CN)

(72) Inventor: Thomas Gerhard Wilhelm Damitz, Qingdao (CN)

(21) Appl. No.: 18/576,569

(22) PCT Filed: Jul. 4, 2022
(86) PCT No.: PCT/CN2022/103667

§ 371 Date: Jan. 4, 2024

(30) Foreign Application Priority Data
Jul. 5, 2021 (CN) 202121510642.8

(51) Int. Cl. H01M 4/62; H01M 4/02; H01M 4/36; H01M 4/58; H01M 4/66; H01M 10/0525

(52) U.S. Cl. CPC H01M 4/625; H01M 4/364; H01M 4/5825; H01M 4/661; H01M 10/0525; H01M 2004/021; H01M 2004/027; H01M 2004/028

(57) ABSTRACT

A lithium ion battery is disclosed. The lithium ion battery includes: a positive electrode current collector with positive electrode active material disposed on a surface thereof; a negative electrode current collector with negative electrode active material disposed on a surface thereof, and the negative electrode current collector being disposed opposite to the positive electrode current collector; a separator and electrolyte disposed between the positive electrode active material and the negative electrode active material; a positive electrode column in electrical contact with the positive electrode current collector; a negative electrode column in electrical contact with the negative electrode current collector; and an outer housing enclosing the positive and negative electrode current collectors, the separator and electrolyte, and wherein the positive and negative electrode columns pass through the outer housing; wherein, the surfaces of the positive electrode current collector and the negative electrode current collector include an orderly and/or randomly textured structure.

### TECHNICAL FIELD

The present application relates to the field of battery, and in particular, to a lithium ion battery.

### BACKGROUND

A rechargeable lithium ion battery generally includes one or more electrochemical cells, each having a negative electrode, a positive electrode, and electrolyte for conducting lithium ions between the negative and positive electrodes. A porous separator wetted with liquid electrolyte solution may be sandwiched between the negative and positive electrodes to physically separate and electrically insulate the electrodes from each other while permitting free ion flow. Each of the negative and positive electrodes is typically carried on or connected to a metallic current collector. The current collectors may be connected to each other by an interruptible external circuit through which electrons can pass from one electrode to the other while lithium ions migrate in the opposite direction through the electrochemical cell during charging and discharge of the battery.

During discharge, the negative electrode contains a relatively high concentration of intercalated lithium, which is oxidized into lithium ions and electrons. The lithium ions travel from the negative electrode (cathode) to the positive electrode (anode) through the electrolyte (i.e. through porous separator). At the same time, the electrons pass through the external circuit from the negative electrode to the positive electrode. The lithium ions are assimilated into the material of the positive electrode by an electrochemical reduction reaction. The battery may be recharged by an external power source after a partial or full discharge of its available capacity, which reverses the electrochemical reaction that occurred during discharge.

During re-charge, intercalated lithium in the positive electrode is oxidized into lithium ions and electrons. The lithium ions travel from the positive electrode to the negative electrode via the electrolyte (i.e. through the porous separator), and the electrons pass through the external circuit to the negative electrode. The lithium cations are reduced to elemental lithium at the negative electrode and stored in the material of the negative electrode for reuse.

### SUMMARY

The application provides a lithium ion battery, which increase the contact surface areas of the positive electrode current collector and the negative electrode current collector, thereby reducing the conductive internal resistance of the positive electrode current collector and the negative electrode current collector, increasing the electrical conductivity of the positive electrode current collector and the negative electrode current collector. In addition, by coating the conductive material on the positive electrode current collector and the negative electrode current collector, respectively, the conductive internal resistance can be further reduced, and the electrical conductivity can be further increased.

In an aspect of the present application, a lithium ion battery is provided. The lithium ion battery includes: a positive electrode current collector, wherein positive electrode active material is disposed on a surface of the positive electrode current collector; a negative electrode current collector, wherein negative electrode active material is disposed on a surface of the negative electrode current collector, and the negative electrode current collector is disposed opposite to the positive electrode current collector; a separator and electrolyte disposed between the positive electrode active material and the negative electrode active material; a positive electrode column in electrical contact with the positive electrode current collector; a negative electrode column in electrical contact with the negative electrode current collector; and an outer housing enclosing the positive electrode current collector, the negative electrode current collector, the separator and electrolyte, and wherein the positive electrode column and the negative electrode column pass through the outer housing; wherein, the surfaces of the positive electrode current collector and the negative electrode current collector include an orderly and/or randomly textured structure.

Optionally, in some embodiments, a conductive material layer having a thickness ranging from 0.5 microns to 2 microns is respectively disposed between the positive electrode current collector and the positive electrode active material, and between the negative electrode current collector and the negative electrode active material.

Optionally, in some embodiments, the conductive material layer is formed of graphene and/or carbon nanotubes.

Optionally, in some embodiments, the positive electrode current collector is made of an aluminum foil having a thickness ranging from 12 microns to 25 microns.

Optionally, in some embodiments, the negative electrode current collector is made of a copper foil having a thickness ranging from 6 microns to 18 microns.

Optionally, in some embodiments, the positive electrode active material includes at least one of lithium manganite (LiMn₂O₄), lithium cobaltate (LiCoO₂), and lithium iron phosphate (LiFePO₄).

Optionally, in some embodiments, the negative electrode active material includes at least one of graphite, a mixture of graphite and silicon, titanium dioxide (TiO₂), and lithium titanate (Li₄Ti₅O₁₂).

Optionally, in some embodiments, the textured structure includes a plurality of dimples in the surface.

Optionally, in some embodiments, each of the plurality of dimples has a depth greater than zero and less than or equal to 5 microns and an opening diameter greater than zero and less than or equal to 100 microns.

Optionally, in some embodiments, the surfaces of the positive electrode current collector and the negative electrode current collector and the surfaces of the plurality of dimples further include a randomly textured structure obtained by surface roughening.

### BRIEF DESCRIPTION OF DRAWINGS

In order to illustrate the technical solutions in embodiments of the application more clearly, the drawings needed to be used in the description of the embodiments will be introduced briefly in the following. Apparently, the drawings in the following description are only some embodiments of the application, and for those having ordinary skills in the art, other drawings can be obtained according to these drawings under the premise of not paying out creative work.

FIG. 1 is a schematic structural diagram of a lithium ion battery according to an embodiment of the present application;

FIG. 2 is a schematic structural diagram of a current collector in the lithium ion battery shown in FIG. 1;

FIG. 3 is a cross-sectional view of the current collector shown in FIG. 2 taken along the plane F and observed along the direction A-A; and

FIG. 4 schematically shows the situation after the current collector shown in FIG. 2 has been treated by surface roughening.

It should be understood that the drawings are only used to explain the embodiments, and thus are not necessary to be drawn on scale. Like reference signs in the drawings denote the same or similar components, elements and parts.

### DETAILED DESCRIPTION OF EMBODIMENTS

In the following, the technical solutions in embodiments of the application will be described clearly and completely in connection with the drawings of the embodiments of the application. Apparently, the described embodiments are only some embodiments of the application, not all embodiments thereof. Based on the embodiments in the application, all other embodiments obtained by those having ordinary skills in the art under the premise of not paying out creative work fall within the protection scope of the application.

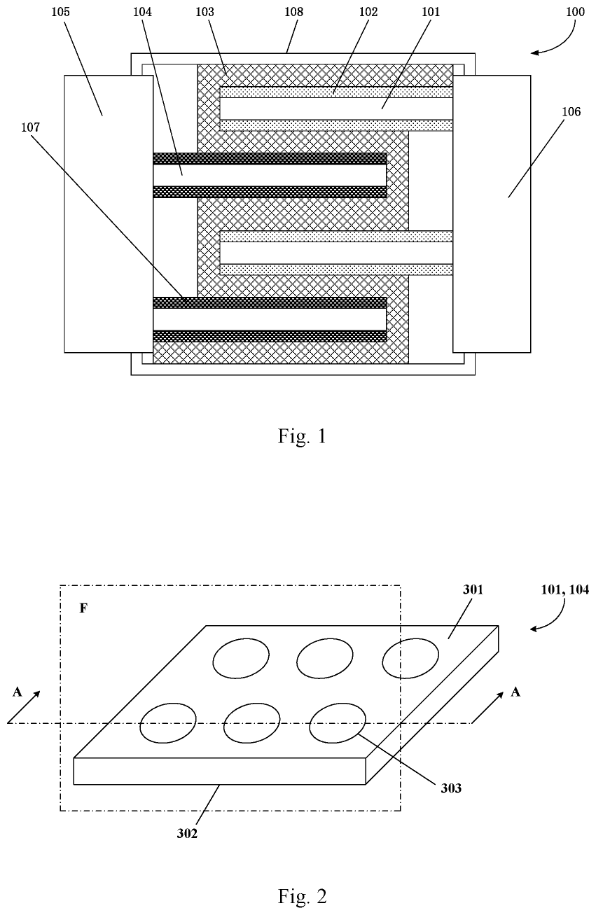

In an aspect of the present application, a lithium ion battery is provided. Referring to FIG. 1, the lithium ion battery 100 includes: a positive electrode current collector 101, wherein positive electrode active material 102 is disposed on a surface of the positive electrode current collector 101; a negative electrode current collector 104, wherein negative electrode active material 107 is disposed on a surface of the negative electrode current collector 104, and the negative electrode current collector 104 is disposed opposite to the positive electrode current collector 101; a separator and electrolyte 103 disposed between the positive electrode active material 102 and the negative electrode active material 107; a positive electrode column 106 in electrical contact with the positive electrode current collector 101; a negative electrode column 105 in electrical contact with the negative electrode current collector 104; and an outer housing 108 enclosing the positive electrode current collector 101, the negative electrode current collector 104, the separator and electrolyte 103, and wherein the positive electrode column 102 and the negative electrode column 104 pass through the outer housing 108; wherein, the surface of the positive electrode current collector 101 and the surface of the negative electrode current collector 104 include an orderly and/or randomly textured structure. The separator and electrolyte 103 extends between the positive electrode current collector 101 and the negative electrode current collector 104 in a series of “ [symbol] ” shapes, thereby surrounding the positive electrode current collector 101 and the negative electrode current collector 104, and separating the positive electrode current collector 101 and the negative electrode current collector 104 from each other. It should be understood that, in the present disclosure, the term “orderly textured structure” refers to a textured structure formed on the surface of the current collector by arranging microstructures with specific shapes and structures in the form of an array according to a certain rule, as will be described with reference to FIG. 2 hereinafter, and the term “randomly textured structure” refers to a textured structure formed on the surface of the current collector by arranging microstructures without specific shapes and structures without any rule. Therefore, in the present disclosure, the term “randomly textured structure” also includes the textured structure of the roughened surface formed on the surface of the current collector by a suitable surface roughening treatment.

In the embodiments of the application, the positive electrode current collector 101 can be made of an aluminum foil having a thickness ranging from 12 microns to 25 microns. In the other embodiments of the application, the negative electrode current collector can be made of a copper foil having a thickness ranging from 6 microns to 18 microns. In the lithium ion battery 100 of the present application, by surface-treating the positive electrode current collector 101, the surface area thereof is increased by at least 1.5 times on the original basis, thereby reducing the conductive internal resistance of the aluminum foil and increasing its conductivity; and further, by surface-treating the negative electrode current collector 104, the surface area thereof is increased by at least 1.3 times on the original basis, thereby reducing the conductive internal resistance of the copper foil and increasing its electrical conductivity. Thereby, the fast charge and discharge capability of the lithium ion battery 100 can be realized.

In the embodiments of the application, a conductive material layer having a thickness in the range of 0.5 microns to 2 microns may be disposed between the positive electrode current collector 101 and the positive electrode active material 102. Optionally, a conductive material layer having a thickness in the range of 0.5 microns to 2 microns may be disposed between the negative electrode current collector 104 and the negative electrode active material 107 as well. In the embodiments of the application, the conductive material layer is formed of graphene and/or carbon nanotubes.

Aluminum has a resistivity of 2.83×10⁻⁸ Ωm, copper has a resistivity of 1.75×10⁻⁸ Ωm, and graphene and carbon nanotubes have a smaller resistivity. Therefore, by providing the conductive material layer formed by graphene and/or carbon nanotubes, the conductive internal resistance of the positive electrode current collector 101 and the negative electrode current collector 104 can be further reduced to increase their electrical conductivity.

Optionally, in some embodiments, the positive electrode active material 102 may comprise at least one of lithium manganite (LiMn₂O₄), lithium cobaltate (LiCoO₂), and lithium iron phosphate (LiFePO₄).

Optionally, in some embodiments, the negative electrode active material 107 may comprise at least one of graphite, a mixture of graphite and silicon, titanium dioxide (TiO2), and lithium titanate (Li4Ti5O12).

Referring to FIG. 2, it schematically shows the structures of the current collectors 101 and 104 in the lithium ion battery shown in FIG. 1. As shown in FIG. 2, the current collectors 101, 104 have a first surface 301 and an opposing second surface 302. A plurality of circular dimples 303 may be provided on the first surface 301 to form the textured structure on the surface. It should be understood that the shape of the dimple 303 can also be any other suitable shape, such as a triangle, a rectangle, an ellipse, etc., and the shape of the dimple 303 is not specifically limited herein. Optionally, in some embodiments, a plurality of dimples 303 may also be provided on the second surface 302.

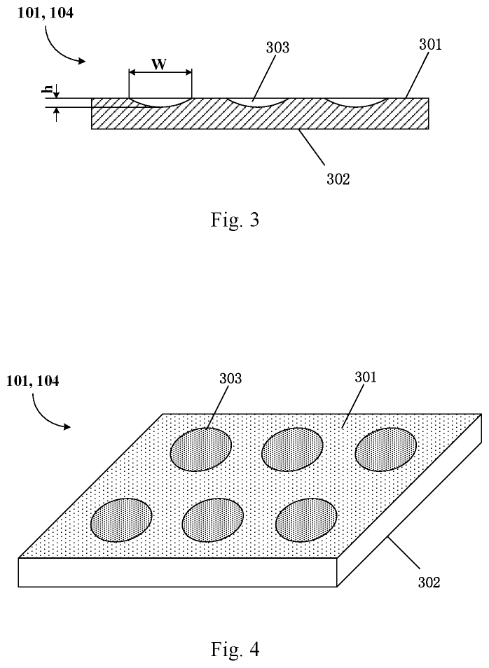

Referring to FIG. 3 in conjunction with FIG. 2, a cross-sectional view of the current collectors 101, 104 of FIG. 2 taken along the plane F and viewed along the direction A-A is shown. As shown in FIG. 3, each dimple 303 has a depth h and an opening diameter W. Optionally, in some embodiments, the depth h may be in a range of greater than zero and less than or equal to 5 microns, and the opening diameter W may be in a range of greater than zero and less than or equal to 100 microns. It should be pointed out that FIG. 2 and FIG. 3 only show an exemplary embodiment of the textured structure on the surfaces of the current collectors, but the textured structure on the surfaces of the current collectors according to the present application is not limited thereto. For example, the first surface 301 and/or the second surface 302 may alternatively or additionally be provided with at least one of the following: a plurality of protrusions, a plurality of concave-convex stripes, and a plurality of grids.

Referring to FIG. 4, it schematically shows the situation after the surface roughening treatment is performed on the current collectors 101, 104 shown in FIG. 2. In the case where the first surface 301 and/or the second surface 302 has(have) a plurality of dimples 303, the current collectors 101, 104 may be subjected to surface roughening treatment by a suitable chemical reagent, so that the first surface 301, the second surface 302 and the surfaces of the plurality of dimples 303 are roughened to additionally obtain a randomly textured structure, so that the specific surface area of the current collectors 101 and 104 can be further increased, the conductive internal resistance thereof can be further reduced, and the conductive capability thereof can be further increased. Alternatively, in some embodiments, the chemical reagent may be hydrochloric acid or sulfuric acid.

The indefinite articles “a” and “an” as used herein in the specification and in the claims, unless clearly indicated to the contrary, should be understood to mean “at least one”.

The phrase “and/or” as used herein in the specification and in the claims, should be understood to mean “either or both” of the elements as so conjoined, i.e., elements that are present conjunctively in some instances and separately in others. Multiple elements listed with “and/or” should be construed in the same way, i.e., “one or more” of the elements as so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer: in one embodiment, to A only (optionally including elements other than B); in another embodiment, to B only (optionally including elements other than A); in yet another embodiment, to both A and B (optionally including other elements); etc.

As used herein in the specification and in the claims, the phrase “at least one” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements other than the elements specifically identified within the list of elements to which the phrase “at least one” refers may optionally be present, whether related or unrelated to those elements specifically identified. Thus, as a non-limiting example, “at least one of A and B” (or equivalently, “at least one of A or B”, or equivalently “at least one of A and/or B”) can refer: in one embodiment, to at least one A (optionally including more than one A), with no B present (and optionally including elements other than B); in another embodiment, to at least one B (optionally including more than one B), with no A present (and optionally including elements other than A); in yet another embodiment, to at least one A (optionally including more than one A), and at least one B (optionally including more than one B) (and optionally including other elements); etc.

In the claims, as well as in the specification above, all transitional phrases such as “comprising”, “including”, “carrying”, “having”, “containing”, “involving”, “holding”, “composed of” and the like are to be understood to be open-ended, i.e., to mean including but not limited to. Only the transitional phrases “consisting of” and “consisting essentially of” shall be close-ended or semiclose-ended transitional phrases, respectively.

The above mentioned are only the embodiments of the present application, but the scope of protection of the present application is not limited to this. Any technical person familiar with the technical field can easily think of changes or substitutions within the technical scope disclosed by present application, which should fall within the scope of protection of the present application. Therefore, the scope of protection of the present application should be based on the scopes of protection of the claims.

1. A lithium ion battery, comprising:
a positive electrode current collector, wherein positive electrode active material is disposed on a surface of the positive electrode current collector;
a negative electrode current collector, wherein negative electrode active material is disposed on a surface of the negative electrode current collector, and the negative electrode current collector is disposed opposite to the positive electrode current collector;
a separator and electrolyte disposed between the positive electrode active material and the negative electrode active material;
a positive electrode column in electrical contact with the positive electrode current collector;
a negative electrode column in electrical contact with the negative electrode current collector; and
an outer housing enclosing the positive electrode current collector, the negative electrode current collector, the separator and electrolyte, and wherein the positive electrode column and the negative electrode column pass through the outer housing;
wherein, the surfaces of the positive electrode current collector and the negative electrode current collector comprise an orderly and/or randomly textured structure.

2. The lithium ion battery according to claim 1, wherein a conductive material layer having a thickness ranging from 0.5 microns to 2 microns is respectively disposed between the positive electrode current collector and the positive electrode active material, and between the negative electrode current collector and the negative electrode active material.

3. The lithium ion battery according to claim 2, wherein the conductive material layer is formed of graphene and/or carbon nanotubes.

4. The lithium ion battery according to claim 1, wherein the positive electrode current collector is made of an aluminum foil having a thickness ranging from 12 microns to 25 microns.

5. The lithium ion battery according to claim 1, wherein the negative electrode current collector is made of a copper foil having a thickness ranging from 6 microns to 18 microns.

6. The lithium ion battery according to claim 1, wherein the positive electrode active material comprises at least one of lithium manganate, lithium cobaltate, and lithium iron phosphate.

7. The lithium ion battery according to claim 1, wherein the negative electrode active material comprises at least one of graphite, a mixture of graphite and silicon, titanium dioxide, and lithium titanate.

8. The lithium ion battery according to claim 1, wherein the textured structure comprises a plurality of dimples in the surfaces.

9. The lithium ion battery according to claim 8, wherein each of the plurality of dimples has a depth greater than zero and less than or equal to 5 microns and an opening diameter greater than zero and less than or equal to 100 microns.

10. The lithium ion battery according to claim 8, wherein the surfaces of the positive electrode current collector and the negative electrode current collector and the surfaces of the plurality of dimples further comprise a randomly textured structure obtained by surface roughening.
